(19) United States
(12) Patent Application Publication
(10) Pub. No.: US 2026/0081286 A1
(43) Pub. Date: Mar. 19, 2026

(54) MODULAR ENERGY STORAGE AND DELIVERY SYSTEM

(71) Applicants: Beta Sentient, LLC, Austin, TX (US); Joule Case, Inc., Seattle, WA (US)

(72) Inventors: Willem Vonk, Austin, TX (US); Justin LeVrier, Austin, TX (US)

(21) Appl. No.: 19/256,099

(22) Filed: Jun. 30, 2025

Related U.S. Application Data
(60) Provisional application No. 63/666,078, filed on Jun. 28, 2024.

(51) Int. Cl. H01M 50/258; H01M 50/24; H01M 50/242; H02J 3/46; H02J 7/00; H02J 7/34

(52) U.S. Cl. CPC H01M 50/258; H01M 50/24; H01M 50/242; H02J 3/46; H02J 7/34; H02J 7/80; H02J 2101/24; H02J 2103/30

(57) ABSTRACT

A modular energy storage and delivery system for tactical operations is disclosed. The system employs standardized modules housing energy storage components and power electronics, which can be easily assembled and configured to provide scalable power capacity and distribution. The modules are designed for quick deployment, environmental adaptability, and integration with various independently functional elements. A power distribution unit serves as the central hub for power management. The system's modular architecture allows for scalability and customization based on mission requirements. Advanced software features utilizing AI/ML can be utilized to optimize power management and system configurations.

### CROSS REFERENCE

This application claims priority to U.S. Provisional Patent Application Ser. No. 63/666,078, titled MODULAR ENERGY STORAGE AND DELIVERY SYSTEM, filed on Jun. 28, 2024, which is incorporated herein by reference in its entirety.

### TECHNICAL FIELD

The present disclosure relates generally to energy storage and power distribution systems. More specifically, the disclosure pertains to a modularized and scalable energy storage and delivery system especially suited for tactical expeditionary operations.

### BACKGROUND

Traditional energy storage and delivery methods, such as generators and fixed battery systems, pose several challenges for tactical operations. These systems often lack portability, scalability, and adaptability to varying power demands and environmental conditions. Generators are noisy, consume fuel continuously, and have high thermal and electromagnetic signatures. Battery systems frequently require complex installations and technical expertise.

There is a need for a modular, scalable, and easily deployable energy storage and delivery solution that can be tailored to specific operational requirements while enabling efficient power management. The present invention addresses these needs by providing a system employing standardized modules to support diverse tactical operations with on-demand, right-sized power.

For further background, the reader is invited to review the following patent assigned to Joule Case, Inc.: International Application (PCT) No. PCT/US24/32046, titled WIDE AREA SITE POWER AND NESTED ENERGY TRANSMISSION (WASP NET), filed May 31, 2024. This application describes a system and methods of deploying a single-point or multi-point node or array having the abilities to further nest appliances and devices within any point or node within that array to transmit power. The system takes advantage of new direct current (DC) technologies and provides a new way to transmit power over a physical area. This system provides a reduction in the number of electrical conductors needed compared to four conductors for alternating current (AC) technology or using similar numbers of conductors can increase the total amount of power the conductors can carry. The WASP-NET system is relevant to the present METEOR application in several ways: (METEOR is a trademark of Beta Sentient, LLC, a co-applicant of this patent application.)
(1) Both systems address the need for modular and flexible power solutions, particularly in situations where traditional grid power may be unavailable or unreliable.
(2) The WASP-NET system utilizes high-voltage DC (HVDC) transmission for power distribution, which complements the present application's (METEOR's) focus on efficient and adaptable power delivery.
(3) Both systems employ a modular approach to energy storage and distribution. WASP-NET uses power cell modules that can be stacked and interconnected, similar to METEOR's standardized energy storage modules.
(4) WASP-NET incorporates intelligent power management features, including control systems for managing power distribution and sharing among nodes. This aligns with METEOR's emphasis on advanced software and AI/ML capabilities for optimizing power distribution.
(5) Both systems aim to provide scalable and reconfigurable power solutions that can adapt to changing power requirements in various operational scenarios.

While the WASP-NET system focuses more on creating a DC-based power distribution network with multiple nodes and power sources, it shares common goals with the present application in terms of providing flexible, modular, and intelligent power solutions for diverse applications. The WASP-NET system is therefore a relevant solution in the field of modular and adaptable power systems, particularly those designed for temporary or remote installations.

### SUMMARY

The present disclosure describes a novel modular energy storage and delivery system for tactical operations. The system comprises a set of standardized modules that can be easily combined and configured to create a tailored power solution for specific operational needs. This modular design allows for the integration of various independently functional elements, such as communications, mechanical, or electrical systems, into a cohesive unit that relies on a reliable and individualized electric power system.

The modules are designed for quick assembly by a single person without requiring technical expertise, significantly enhancing portability and usability. They feature rugged enclosures that can be customized with different materials to withstand specific environmental conditions, including weather resistance and ballistic impact protection. The system's scalable power delivery capabilities enable it to adapt to changing mission requirements by adding, removing, or reconfiguring modules, units, groups, or grids.

A power distribution unit (PDU) serves as the central hub for distributing power from energy modules to connected devices. Energy modules are also referred to herein as energy storage modules (ESMs). The system incorporates advanced software features utilizing AI/ML for load identification, power component pairing, and runtime calculations, optimizing power management and ensuring efficient system configuration. These novel features provide a versatile and adaptable power solution that can be easily deployed and reconfigured for diverse operational requirements.

An illustrative embodiment of a system according to the present invention comprises a plurality of standardized energy storage modules (ESM); at least one power distribution unit (PDU) configured to distribute power from the energy storage modules to connected devices; a plurality of connectors for interconnecting the energy storage modules and the PDU; a user interface for system configuration and monitoring; and a software application. The software application may include a load identification module for categorizing electrical loads; a power component pairing module for matching identified loads with suitable power components; and a runtime calculator for estimating operational runtime based on system configuration and load data.

Other embodiments, features and advantages are described below.

### BRIEF DESCRIPTION OF THE DRAWINGS

The appended drawings illustrate only exemplary embodiments of the invention and therefore to not limit its scope because the inventive concepts lend themselves to other equally effective embodiments.

FIG. 1 is a block diagram illustrating the components of the modular energy storage and delivery system.

FIG. 2 is a flow diagram depicting the operation of the system.

FIG. 3 is a block diagram illustrating the modular and scalable design of the inventive system, in particular depicting a grid of the system.

FIG. 4A is a representation of a power distribution unit (PDU) of the system.

FIG. 4B depicts the system connected together via a ruggedized power bus.

FIG. 4C is a representation of an electrical storage module (ESM) of the system.

FIG. 5 is a block diagram of an electrical storage module (ESM) of the system.

FIG. 6 is a block diagram of a power distribution unit (PDU) of the system.

FIG. 7 is a representation of the heavy-duty cables and connectors used to connect the PDUs and ESMs of the system together.

FIG. 8 is a representation of the independently functional elements that the system may employ.

FIG. 9 is a flowchart depicting process flow in the load identification module of the system.

FIG. 10 is a flowchart depicting process flow in the power component pairing module of the system.

FIG. 11 is a flowchart depicting process flow in the runtime calculator (PDU side) of the system.

FIG. 12 is a flowchart depicting process flow in the runtime calculator (ESM side) of the system.

FIG. 13A shows the login screen of the operational energy dashboard of the user interface of the system.

FIG. 13B shows the main view screen of the operational energy dashboard of the user interface of the system.

FIG. 13C is another view of the operational energy dashboard of the user interface of the system showing nodes of a particular mission.

FIG. 13D is another view of the operational energy dashboard of the user interface of the system showing inside the power node view.

### DETAILED DESCRIPTION

### Overview

The present invention, referred to as the Modular Expeditionary Tactical Energy Operations Resource (METEOR) system, is a novel system that employs a predetermined standardized set of modules to support various tactical operations. (METEOR is a trademark of Beta Sentient, LLC, co-applicant of this patent application). METEOR's modular design allows for the creation of a tailored energy storage and power delivery system that can be easily adapted to specific but unlimited and variable use cases.

The system's architecture enables the integration of independently functional elements, such as communications, mechanical, or electrical systems, into a cohesive unit that relies on a stable and uninterrupted power supply. This adaptability ensures that each component operates optimally within the larger system, providing a versatile and customizable power solution that can be easily reconfigured for diverse and changing operational requirements.

METEOR's scalable power delivery capabilities allow the system to adapt to evolving mission requirements by adding, removing, or reconfiguring modules, units, groups, or grids. The easy assembly and deployment features, combined with the environmental adaptability of the modules, make the system highly portable and usable in various tactical scenarios.

The incorporation of advanced software features utilizing artificial intelligence/machine learning (AI/ML) for load identification, power component pairing, and runtime calculations further enhances the system's efficiency and adaptability. These novel features optimize power management and ensure efficient system configuration, providing a reliable and individualized electric power system for diverse operational needs.

### System Architecture

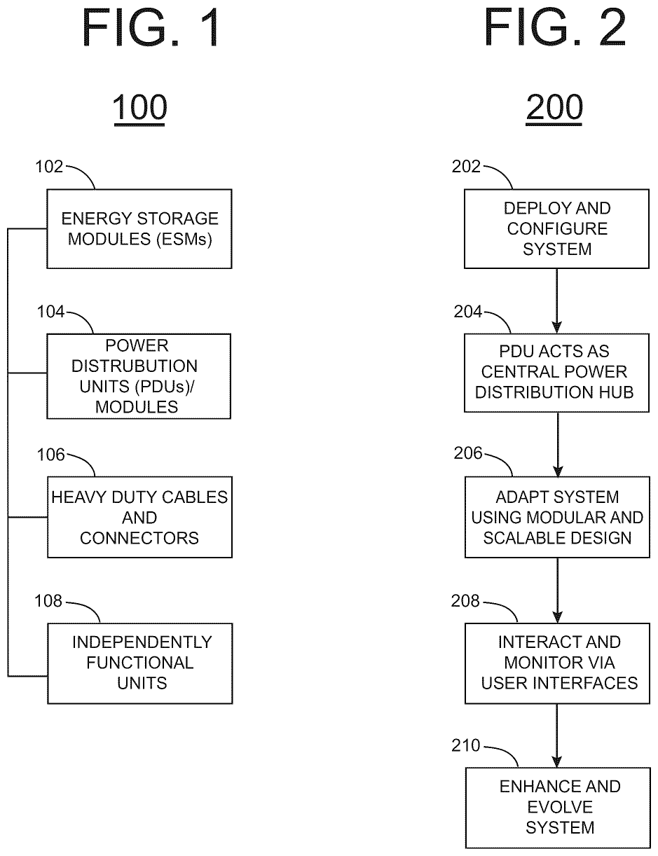

Referring to FIG. 1, a block diagram of the METEOR system is shown. The system comprises a set of energy storage modules ESMs 102, each ESM housing battery packs or other energy storage components. Power distribution units (PDUs) 104 serve as central hubs for distributing power from the energy storage modules to connected devices or other modules. The PDUs may also integrate charging capabilities, allowing the energy storage modules to be recharged from mains power, solar panels, or other PDUs.

The modules are interconnected using heavy-duty cables and connectors 106. These connectors enable the linking of multiple modules to form scalable power delivery and energy storage configurations. The modular design allows for the system to be scaled up or down by adding, changing, or removing modules based on operational requirements.

The system architecture supports the integration of independently functional elements 108, such as communications, mechanical, or electrical systems, within the modules. These elements rely on the stable and uninterrupted power provided by the METEOR system.

### Operation

FIG. 2 illustrates a flow diagram depicting the operation of the METEOR system. The process begins with the deployment and configuration of the system (step 202). Individual modules can be deployed to provide localized power, or multiple modules can be interconnected to create scalable power capacity and distribution configurations.

The PDU acts as the central power distribution hub (step 204). It receives power from the energy storage modules and distributes it to connected devices or other modules. The PDU may also facilitate the recharging of energy storage modules from various power sources.

The modular and scalable design of the system allows for adaptability to changing operational demands (step 206). Users can add, change, or remove modules as required, creating customizable power solutions that evolve with mission requirements. The system supports the formation of “Units”, “Groups”, “Nodes”, and “Grids” by combining modules and other components.

User interfaces are provided for system interaction and monitoring (step 208). At a basic level, the interfaces include power on/off controls and visual status indicators. Advanced software features, such as AI/ML-based load identification, power component pairing, and runtime calculations, are envisioned for future enhancements (step 210). These features would optimize power management and system configuration.

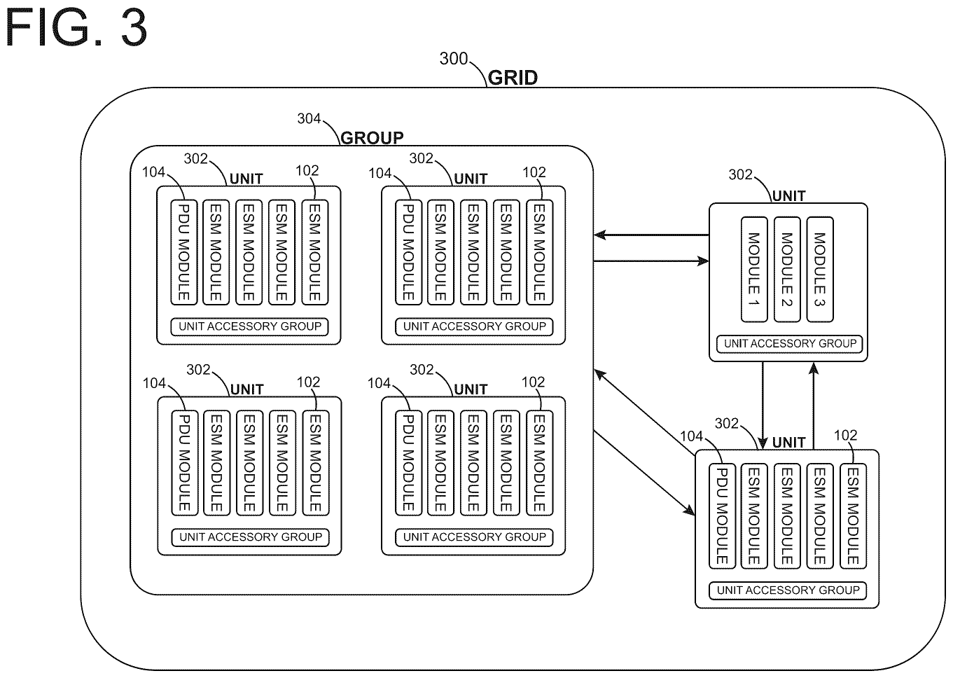

Referring now to FIG. 3, one embodiment of the system is designed to provide a flexible, reliable power solution for tactical expeditionary operations. It addresses the need for scalable, portable, and efficient energy in environments where traditional power sources are impractical. Here below is an overview of the system's operation, function, and use:

### 1—Deployment and Configuration:

Individual Deployment: Each module can be deployed individually to provide localized power for specific equipment or operations. The modules are designed to be easily portable, storable, and transportable.

Configurations: The system allows for scalable power capacity as well as custom individualized power distributions, ensuring that the system can adapt to varying operational demands.

### 2—Power Distribution Unit (PDU)/Module:

The PDU is the central hub for the system. It distributes power from energy storage modules to other connected modules or other connected devices. The PDU may also integrate charging capabilities, allowing the energy storage modules to be recharged from mains power, solar panels or other PDUs. This versatility ensures that the system can be maintained in diverse environments.

### 3—Modular and Scalable Design

As shown in FIG. 3, the modular design of the system means that it can be scaled up or down based on the specific needs of a particular mission. Users can add, change or remove energy storage modules (ESMs) 102 and PDU modules 104 as required, providing a customizable power solution that can evolve with changing operational conditions. As shown in the diagram this modularity extends beyond the modules to Units 302, Groups 304, Nodes and Grids 300.

A Unit 302 is a number of modules acting together to solve a particular tactical need, or to act as a component of a larger configuration such as a Group.

A Group 304 is a combination of Units 302, and acts to solve a particular need, or can be combined with other modules, Units or Groups to form a larger configuration.

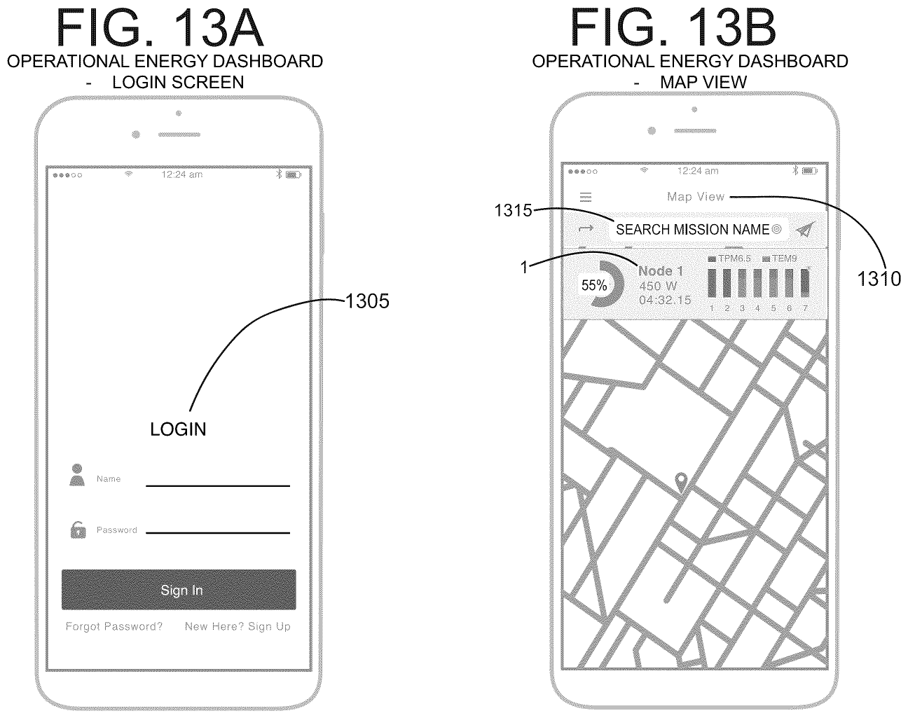

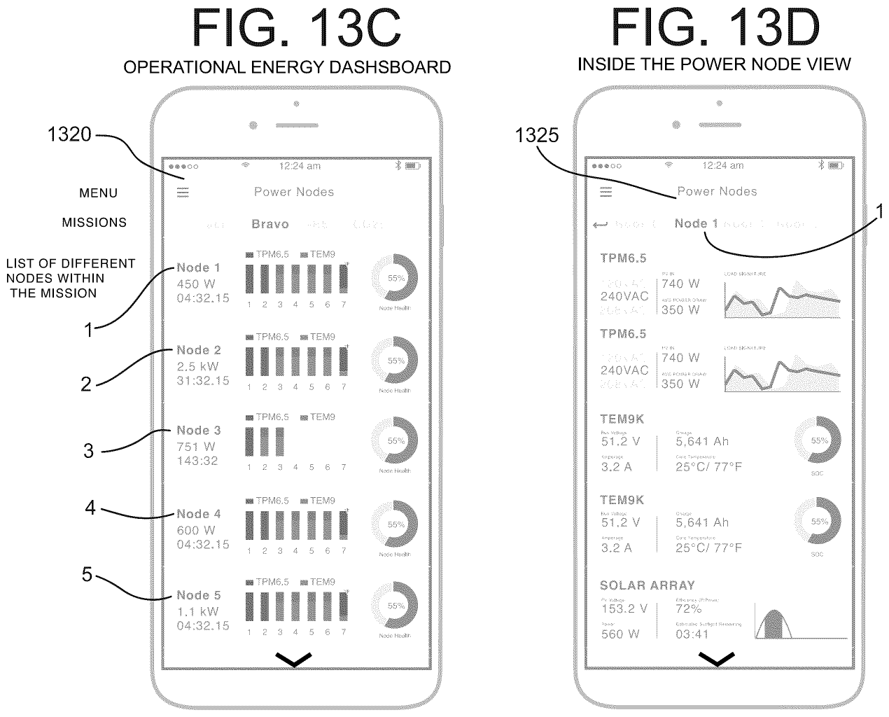

Nodes are considered to be components in a configuration that has a standalone function within the configuration. Nodes are zones or locales where METEOR is situated, for example where an ESM or PDU of the system is located, such as seen in the geographic location in the map view of FIG. 13B.

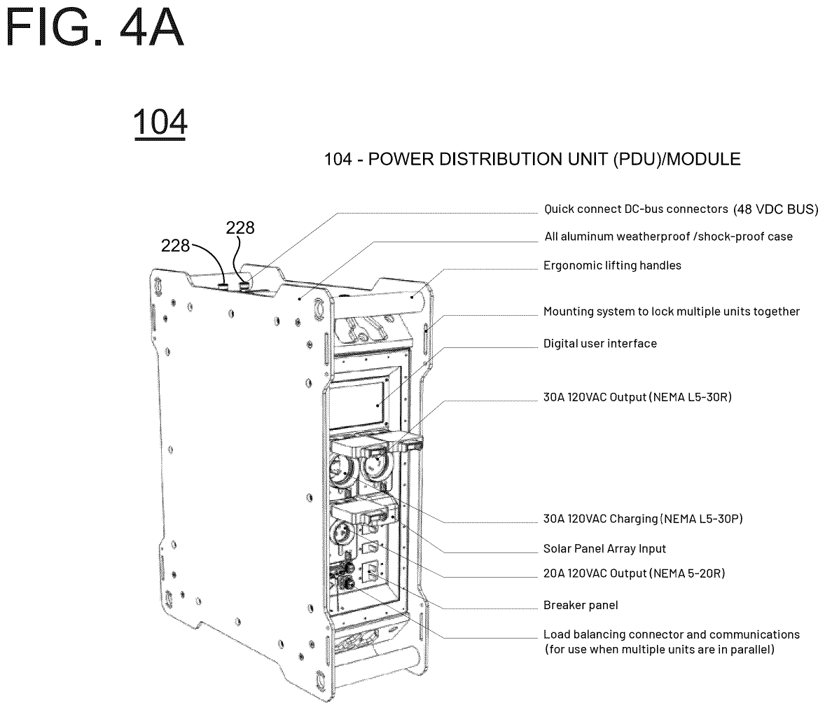

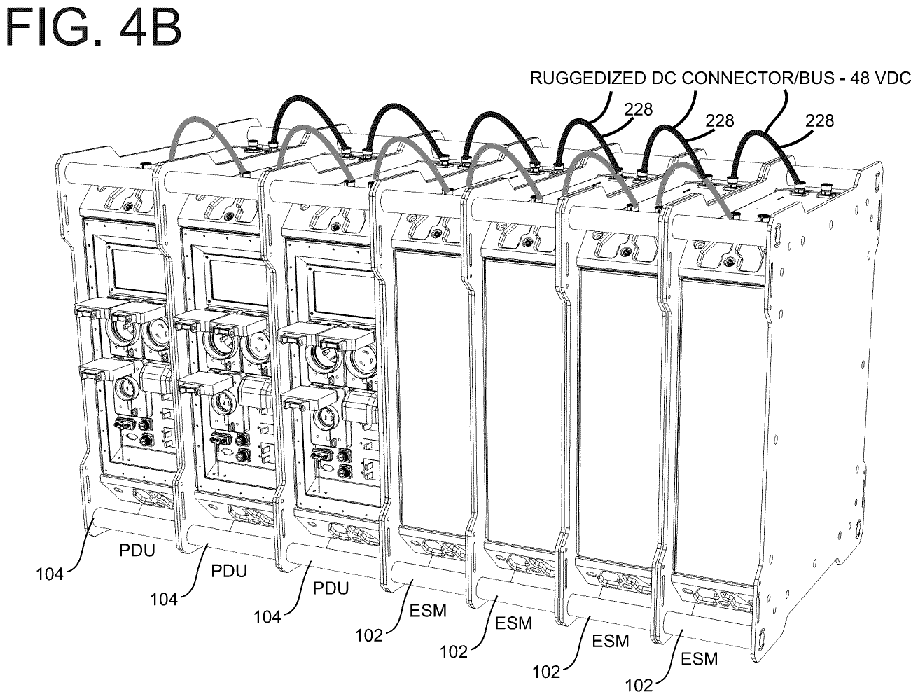

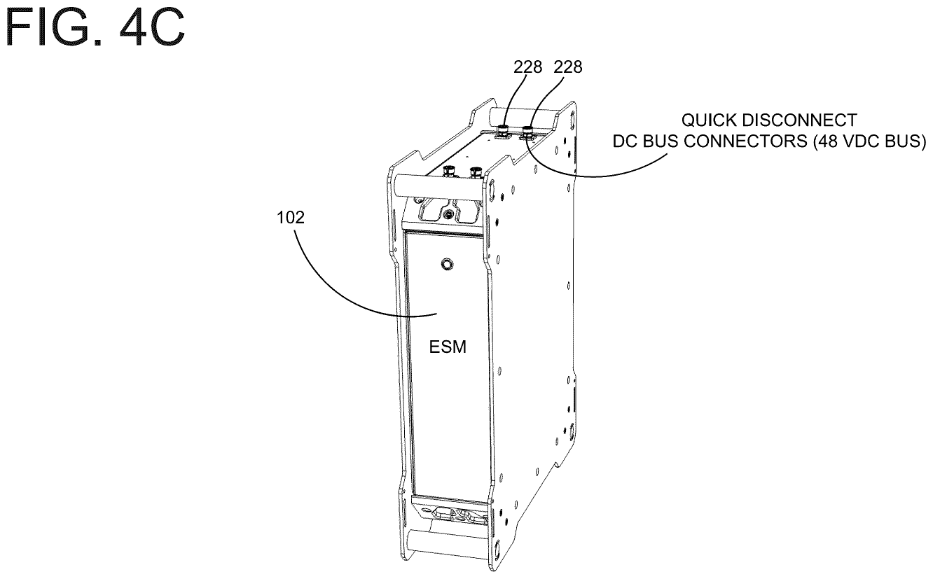

FIGS. 4A, 4B and 4C are representations of an illustrative embodiment. More particularly, FIG. 4A shows a representative power distribution unit (PDU)/module 104. FIG. 4B shows an embodiment wherein multiple PDUs 104 are coupled to multiple ESMs 102 via a ruggedized DC connector bus 228. FIG. 4C is a representation of an energy storage module 102. The following details relate to the embodiment of FIGS. 4A-4C.

Materials: The module enclosures of the modules depicted in FIGS. 4A-4C may be made of a variety of different materials depending on the environment or use case. Acceptable materials include plate and sheet aluminum, aramid fiber composites, carbon fiber composites, steel and other materials. Some materials may be EMF shielding, or rated for ballistic impact resistance, depending on the use case.

Exterior Design: Each module has a rugged utilitarian design reinforced where needed for its specific application and weather-sealed access points where needed. The robust construction protects the internal components from environmental damage.

Interior Design: Each module's interior design follows a protocol that allows for adjustable compartmentalization without compromising the integrity of the exterior or its use case/usability.

Internal Components: The internal components may be any system, assembly, or other set of independently functional elements, such as communications, electrical, mechanical, organic, or other traditional or novel systems and components.

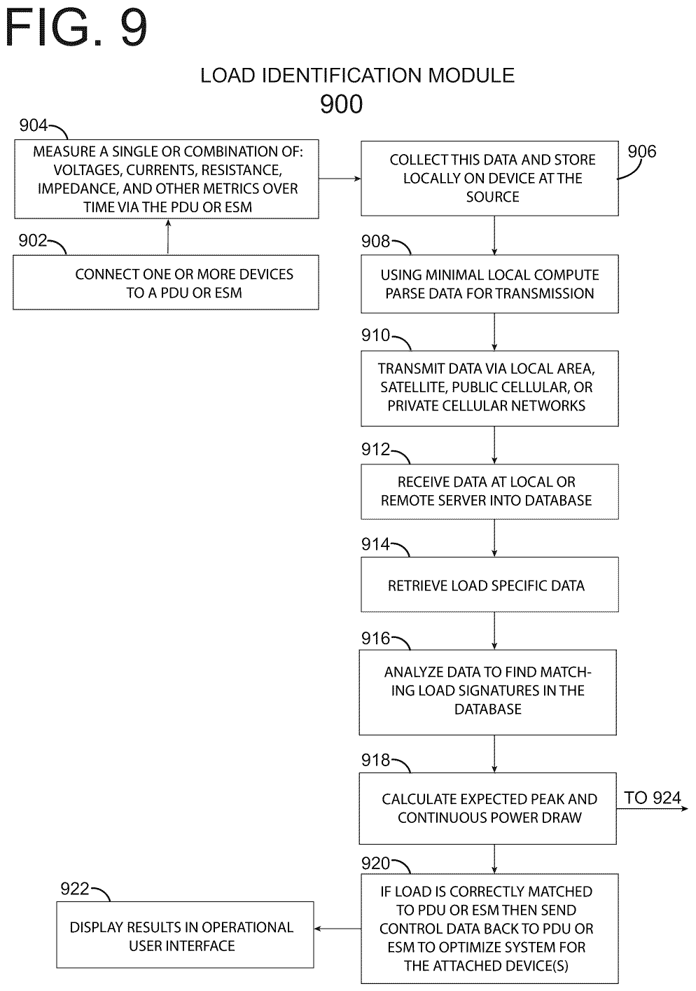

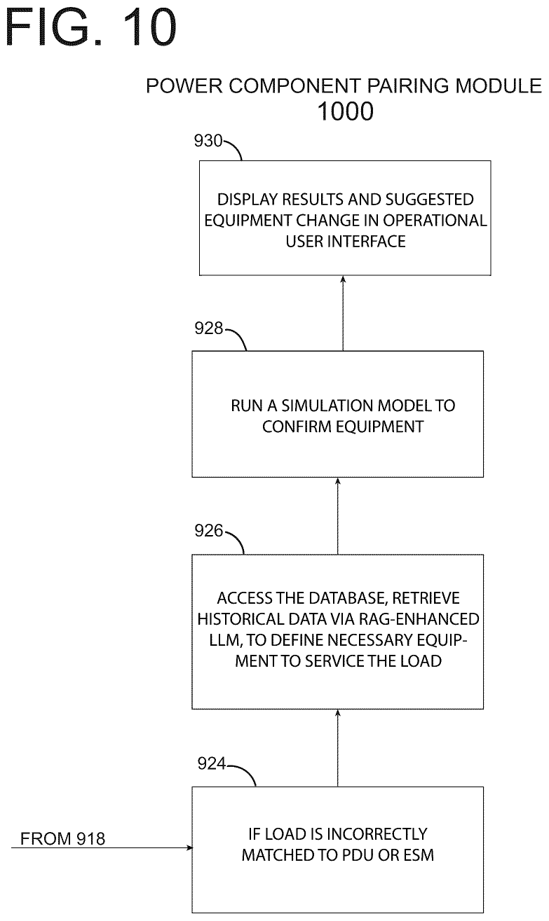

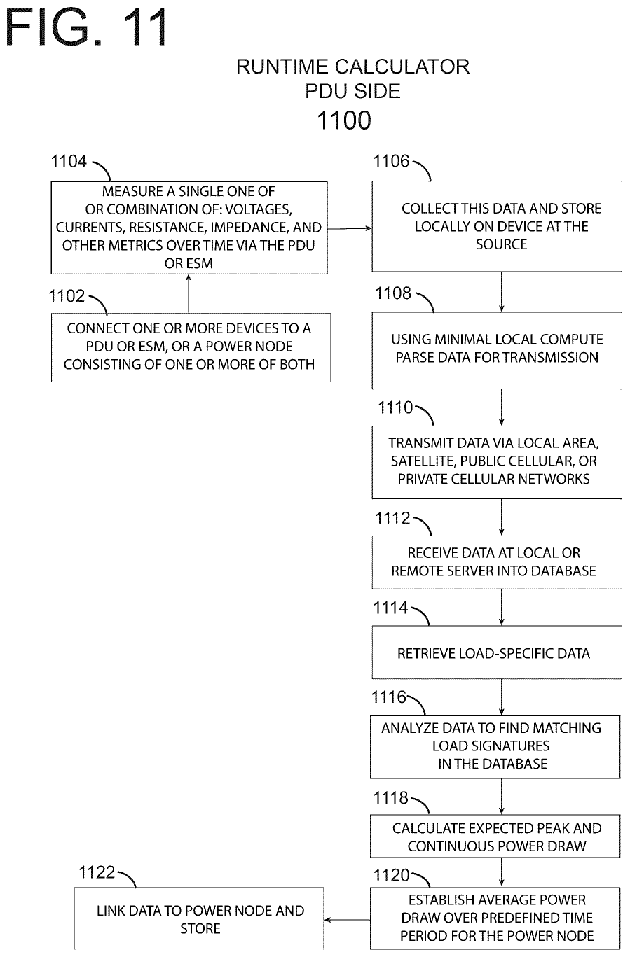

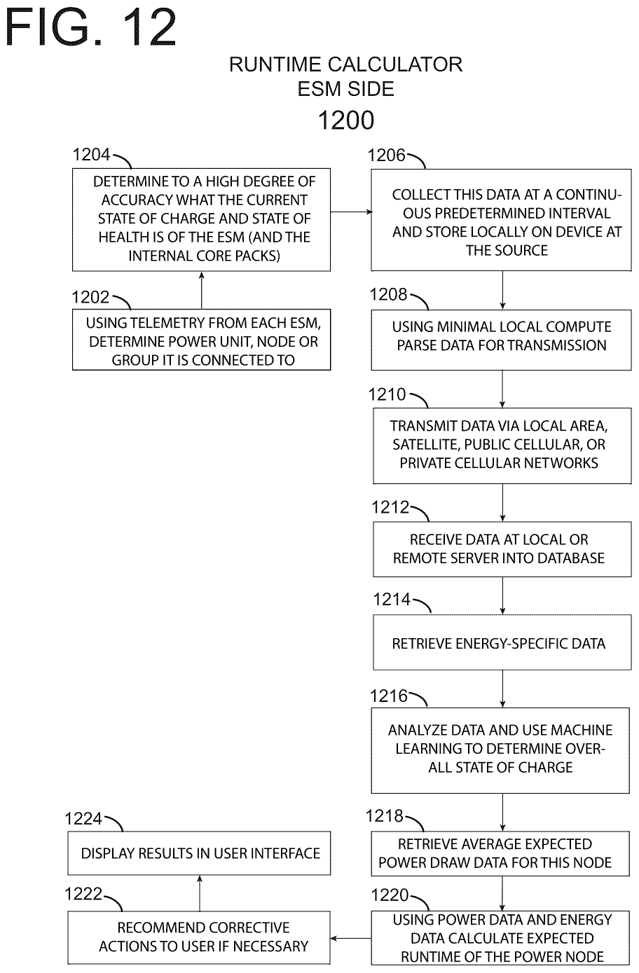

AI and ML Integration: The METEOR system incorporates an application program that facilitates the easy configuration and optimization of power systems based on tactical needs. The application is a computer-implemented method and employs several functional components that work together to enhance the system's usability, efficiency, and adaptability, as discussed in more detail below. For example, the application includes a load identification module 900 as seen in FIG. 9, a power component pairing module 1000 as seen in FIG. 10 and a runtime calculator 1100, 1200 as seen in FIGS. 11-12.

Load identification module 900 accurately identifies and categorizes several types of electrical loads. Users input the specifications of their electrical equipment (i.e. power consuming devices), such as power ratings, voltage requirements, and operating characteristics, into a user interface. The load identification module 900 then classifies these loads based on their power requirements and usage patterns. Additional details with respect to load identification module 900 are discussed below with reference to the flowchart of FIG. 9.

By accurately identifying the power demands of various tactical equipment (i.e. electrical loads/power consuming devices), the load identification module 900 enables the system to optimize power distribution and ensure that each device receives the appropriate power supply. This feature eliminates the need for manual calculations and guesswork, reducing the risk of equipment damage or power system overload.

A power component pairing module 1000 is responsible for matching the identified electrical loads with the most suitable modular power components within the METEOR system. This module leverages a comprehensive database of available energy storage modules, PDUs, and connectors to suggest optimal configurations for power distribution and scalability. Additional details with respect to power component pairing module 1000 are discussed below with reference to the flow chart of FIG. 10.

Using optimization methods, the power component pairing module 1000 considers factors such as load requirements, module capacities, and system constraints to determine the most efficient and effective pairing of components. This feature streamlines the system configuration process, ensuring that the power infrastructure is tailored to meet specific operational requirements of electrical loads/power consuming devices while maximizing power resource utilization.

The runtime calculator 1100, 1200 is a tool that provides users with accurate estimates of the operational runtime for the configured power system. By analyzing the input load data and selected power components, the runtime calculator determines expected runtimes considering factors such as power consumption, battery capacity, and environmental conditions. The runtime calculator includes a runtime calculator PDU-side 1100 and a runtime calculator ESM-side 1200 that are discussed in more detail with respect to the flow charts of FIGS. 11 and 12, respectively.

This feature of the runtime calculator enables users to make informed decisions regarding mission planning and resource allocation. With reliable runtime estimates, tactical teams can ensure that they have sufficient power supplies to complete their objectives without the risk of unexpected power outages. The runtime calculator also helps in optimizing battery management, allowing for proactive charging and replacement strategies.

A representative user interface is discussed below with reference to FIGS. 13A-13D. The user interface, namely a configuration and monitoring interface, is a user-friendly software component that simplifies system setup and enables real-time monitoring of the METEOR system. Through this interface, users can configure the power system by specifying load requirements, selecting appropriate modules, and defining operational parameters.

The user interface provides intuitive visualizations and controls, making it accessible to users with varying technical expertise. It offers real-time monitoring capabilities, displaying key metrics such as power consumption, battery status, and system health. Users can set up alerts and notifications to promptly address any issues or anomalies in the system.

The user interface enhances the overall user experience, reducing the complexity of system setup and management. It empowers tactical teams to quickly deploy and adapt the power infrastructure to changing operational needs, while ensuring continuous system oversight and maintenance

The METEOR system can leverage artificial intelligence (AI) and machine learning (ML) to further optimize power management and system configurations. By collecting data from user interactions and system performance logs, the software can build robust models that predict optimal configurations based on historical patterns and real-time inputs.

The AI/ML components can continuously learn from new data, adapting to changing operational conditions and user preferences. This self-learning capability enables the system to make intelligent decisions regarding power allocation, load balancing, and resource optimization.

To ensure the reliability and fairness of the AI/ML models, rigorous bias testing and data preparation techniques are employed. The collected data is labeled, if supervised learning is used, to distinguish between different usage scenarios and system configurations. Bias testing helps identify and mitigate any potential biases in the models, ensuring that the predictions and optimizations are accurate and unbiased across diverse operational conditions.

The integration of AI/ML techniques in the METEOR system has the potential to significantly enhance decision-making for power management, reduce inefficiencies, and adapt to evolving operational needs. By leveraging the power of data-driven insights and predictive modeling, the system can provide intelligent recommendations and automate system configurations, further improving the efficiency and reliability of the power infrastructure in tactical operations.

The adaptability of the METEOR system to changing power requirements and equipment configurations is now discussed. The METEOR system is designed to handle changes in power requirements and equipment configurations during tactical operations. Its modular architecture and advanced software features enable the system to adapt quickly and efficiently to evolving operational needs.

To this end, the METEOR system employs dynamic load monitoring. The system incorporates real-time load monitoring capabilities that continuously track the power consumption of connected devices and equipment. The Load Identification Module, coupled with smart sensors and metering devices, detects any changes in power requirements as tactical operations progress.

When a new electrical power consuming device is connected or an existing device is reconfigured, the system automatically identifies the updated load profile via Load Identification Module 900 which is discussed below with reference to the flowchart of FIG. 9. This information is fed into the Power Component Pairing Module 1000, which dynamically reassesses the optimal configuration of energy storage modules (ESMs) and PDUs to accommodate the changed power requirements. Power Component Pairing Module 1000 is also discussed below with reference to the flowchart of FIG. 10.

The modular design of the METEOR system allows for easy scalability of the power infrastructure during tactical operations. If the power demands increase, additional energy storage modules 102 can be quickly integrated into the system to provide the necessary capacity. The heavy-duty cables and connectors, such as shown in FIG. 4B, facilitate the rapid expansion of the power distribution network.

Similarly, if certain equipment is no longer needed or is replaced with devices having different power specifications, the system can be seamlessly reconfigured. Energy storage modules (ESMs) 102 can be disconnected or swapped out, and the Power Component Pairing Module 1000 will suggest the most efficient redistribution of resources based on the updated load profile.

The METEOR system's advanced features, including the AI/ML integration, enable adaptive power management in response to changing operational conditions. The runtime calculator continuously updates its estimates based on real-time power consumption data and evolving mission parameters.

If the system detects a potential shortfall in power supply due to increased demand or unexpected usage patterns, it can proactively trigger load shedding or prioritize critical loads to ensure uninterrupted operation of essential equipment. The AI/ML algorithms learn from these scenarios and optimize power allocation strategies for future operations.

Via the user interface with configuration and electrical power consuming device monitoring, the METEOR system provides a user-friendly platform for tactical teams to quickly adapt the power system to changing requirements. Through the interface, users can easily add or remove devices, modify load parameters, and adjust system settings.

The user interface offers intuitive visualizations and guided workflows to assist users in reconfiguring the system. It provides real-time feedback on the impact of configuration changes, such as updated runtime estimates and recommended module arrangements, empowering users to make informed decisions during dynamic tactical situations.

The METEOR system can be equipped with remote monitoring and control capabilities, enabling centralized management of the power infrastructure across multiple tactical units or locations. This feature allows for real-time monitoring of power consumption, battery status, and system health from a remote command center.

In the event of changing power requirements or equipment configurations, the remote management team can quickly assess the situation and provide guidance to the tactical units. They can remotely initiate system reconfigurations, optimize power distribution, and ensure that the power infrastructure remains responsive to the evolving needs of the mission.

By incorporating these adaptability features, the METEOR system ensures that tactical teams have access to reliable and efficient power supply even in the face of changing operational demands. The combination of modular hardware, an intelligent application program, and user-friendly interfacing enables the system to handle dynamic power requirements and equipment configurations seamlessly, enhancing the flexibility and resilience of tactical operations.

Illustrative Use Case Example 1: Mobile power supply for field operations A primary use case for the METEOR system is an implementation designed for use without having to assess power needs and do a lot of unnecessary work, such as figuring out power draw and duration thereof, or running long heavy-duty cables. The system provides easily movable power that can be quickly assembled in the field (that would otherwise be too heavy or bulky to move) and which the user can get running in minutes with minimal knowledge of power and energy. The system is essentially plug and play. The user plugs it in and it works. More advanced functions are available too for those who understand power/energy). Advantageously, a young, inexperienced soldier in the field who needs to set up quick power for his mission command tent. Alternatively, special forces operators are able to carry these systems behind enemy lines, for charging batteries on drones and other equipment, operating sensors and communications without the noise of a generator, without the heat signature, and without the need of logistics to deliver fuel. They can essentially throw the system down, click it together, and have the system operational power in minutes.

Illustrative Use Case Example 2: Forward operating base power supply In a military context, the METEOR system can be deployed to provide power for a forward operating base (FOB). The modular nature of the system allows it to be quickly set up and configured to meet the specific power requirements of the FOB.

Upon arrival at the FOB location, the tactical team assesses the power needs based on the equipment and facilities to be supported. Energy storage modules (102) are unloaded and positioned strategically around the base. The number and capacity of the modules are selected based on the anticipated power draw and desired operational duration.

The power distribution units (PDUs) (104) are set up at central locations within the FOB. Heavy-duty cables and connectors (106) are used to link the energy storage modules to the PDUs, creating a robust power distribution network. The PDUs are configured to deliver the appropriate voltage and frequency for the connected equipment.

Independently functional elements (108), such as communications systems, surveillance equipment, and water purification units, are integrated into the METEOR system. These elements are connected to the PDUs to receive reliable and uninterrupted power. The modular design allows for easy expansion or reconfiguration of the power infrastructure as the FOB's requirements evolve. The inventive system is primarily meant to fully replace generators and other power sources currently being used.

The user interfaces provide real-time monitoring of power consumption, battery status, and system health. The advanced software features optimize power management, ensuring efficient utilization of energy resources. The system is primarily meant to be prime power, although it could be configured as well as backup power.

Illustrative Use Case Example 3: Remote construction site power supply In a commercial or industrial setting, the METEOR system can be utilized to power a remote construction site. The modular and scalable design of the system enables it to adapt to the changing power requirements as the construction project progresses.

During an initial site survey, the construction team identifies the power needs for various equipment, such as cranes, welding machines, and power tools. Energy storage modules (102) are transported to the site and strategically placed near the main work areas. The modules are selected based on the anticipated power consumption and the duration of the construction project.

PDUs (104) are installed at key locations on the construction site, such as the main office trailer and equipment staging areas. The energy storage modules are connected to the PDUs using heavy-duty cables and connectors (106), establishing a reliable power distribution network. The PDUs are configured to provide the necessary voltage and amperage for the connected equipment.

Independently functional elements (108), such as site lighting, security systems, and communication equipment, are integrated into the METEOR system. These elements receive power from the PDUs, ensuring their continuous operation. The modular architecture allows for easy expansion of the power infrastructure as the construction project grows or new equipment is added.

User interfaces enable the construction team to monitor power usage, battery charge levels, and system performance. The advanced software features optimize power allocation and provide predictive maintenance insights. In situations where grid power is unavailable or unreliable, the METEOR system ensures uninterrupted power supply, minimizing downtime and maintaining construction progress.

As the construction project nears completion, the METEOR system can be easily scaled down or reconfigured to support the changing power requirements. Modules can be redeployed to other construction sites or stored for future use. The adaptability and portability of the system make it an ideal solution for remote and temporary power needs in the construction industry.

The METEOR system presents a groundbreaking approach to energy storage and delivery for tactical operations. Its novel modular design allows for the creation of tailored power solutions that can be easily adapted to specific mission requirements. The ability to integrate various independently functional elements, such as communications, mechanical, or electrical systems, into a cohesive unit that relies on a reliable and individualized electric power system sets METEOR apart from traditional power solutions. The system's scalable power delivery capabilities, easy assembly and deployment features, and environmental adaptability make it highly versatile and suitable for a wide range of operational scenarios. The incorporation of advanced features that can utilize AI/ML for load identification, power component pairing, and runtime calculations further enhances the system's efficiency and adaptability.

The potential applications of the METEOR system extend beyond tactical operations, as its modular and adaptable design makes it suitable for various industries and sectors. From disaster relief and remote industrial sites to temporary power needs in construction and beyond, the METEOR system offers a reliable, portable, and efficient energy solution that can be easily deployed and reconfigured to meet diverse power requirements. As the demand for flexible and adaptable power solutions continues to grow, the METEOR system is well-positioned to change the way energy storage and delivery are approached across a wide range of applications. Its novel features and advantages make it a promising solution for addressing the evolving power needs of various industries and sectors, ensuring reliable and efficient energy supply in even the most challenging environments.

### System Implementation, Structure and Process Flow

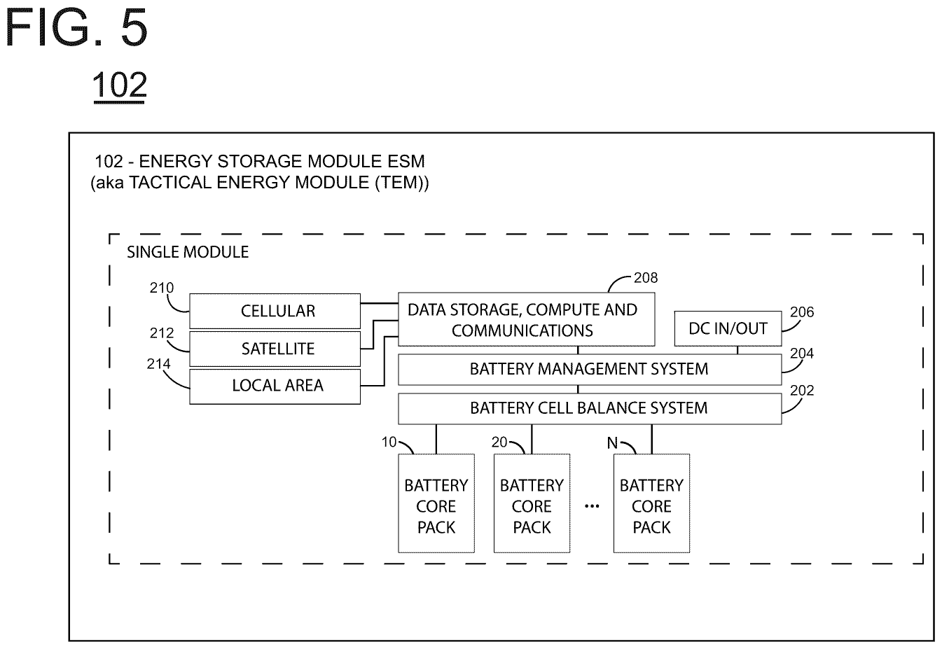

FIG. 5 is a block diagram of a representative energy storage module (ESM) 102. ESM 102 may also be called a tactical energy module (TEM). ESM 102 includes battery core packs 10, 20 . . . N. The battery core packs are preferably lightweight, high energy density battery such as lithium-ion batteries. A battery cell balance system 202 couples to battery core packs 10, 20, . . . N to manage and optimize the performance of these battery packs, to ensure that all cells within the packs are charged and discharged evenly. This is helpful for maximizing usable capacity, extending battery lifespan, and preventing potential safety issues. FIG. 1 shows how ESM 102 couples to other apparatus with the METEOR system.

Battery cell balance system 202 couples to a battery management system (BMS) 204 that provides oversight to the battery packs in the ESM 102. BMS 204 can monitor the battery packs, provide battery protection, estimate the battery packs operational state, and optimize battery performance in cooperation with battery cell balance system 202. BMS 204 also reports operational status to external devices.

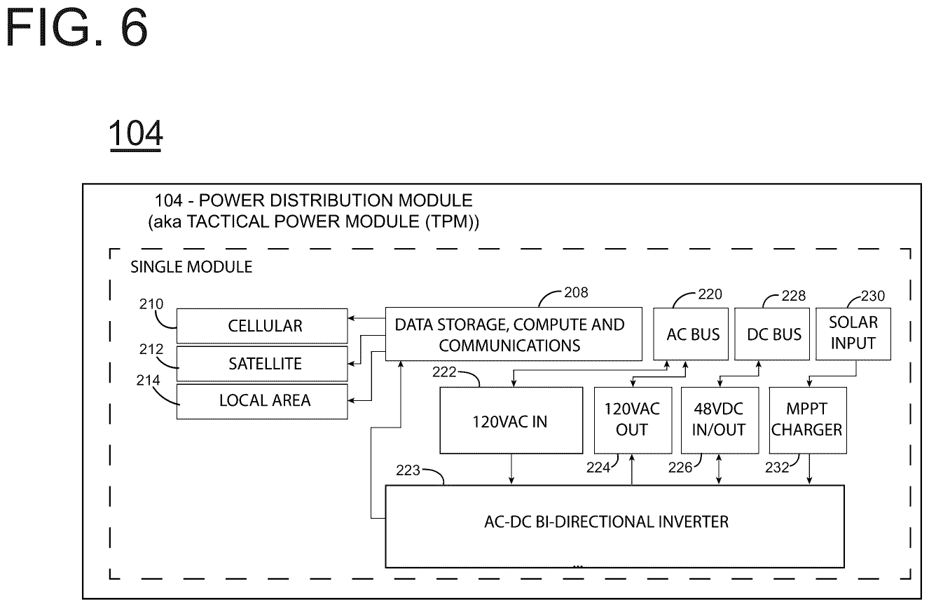

EMS 102 further includes a DC input/output port 206 (DC IN/OUT) that couples to BMS 204. DC input/output port 206 outputs voltage from the battery core packs to power consuming devices external to ESM 102. DC input/output port 206 also receives DC power from other devices such as PDU 104 of FIG. 6 to charge the battery core packs 10, 20, . . . N.

Battery management system (BMS) 204 also couples to data storage, compute and communications block 208. Block 208 stores information concerning battery core packs 1, 2, . . . N such as their state of charge (SoC) information and reports that information back to a predetermined location such as a central database that stores and processes that information to inform users with respect to ESM status. Block 208 can perform such communication via wireless connection such as cellular communication 210, satellite communication 212 or local area network communication 214.

PDU 104 of FIG. 6 and ESM 102 of FIG. 5 include some components in common. Like component labels and like component numbers are used in FIGS. 5 and 6 to identify like components. PDUs 104 may also be referred to as Tactical Power Modules (TPMs) as seen in FIG. 6. To charge the battery packs of an ESM 102 of FIG. 5 coupled to PDU 104 from DC bus 228 of FIG. 6, ESM 102 receives DC power at its DC IN/OUT block 206 shown in FIG. 5. In more detail, referring to PDU 104 of FIG. 6, an AC bus 220 couples via 120 VAC IN block 222 to an AC-DC bi-directional inverter 223 that can convert AC to DC and AC to DC. To charge the battery packs of a connected ESM 102, AC-DC bi-directional inverter 223 converts AC to DC that it supplies via 48 VDC IN/OUT block 226 to DC bus 228 for distribution to ESM 102 or multiple ESMs 102. Alternatively, PDU 104 can charge ESM battery packs via solar input 230 and an MPPT charger 232. Solar input 230 can couple to an external solar array to receive energy therefrom. MPPT charger 232 is a maximum power point tracker type charger, namely an electronic DC to DC converter that optimizes the match between a solar array and the battery bank. It converts a higher voltage DC output from solar panels down to the lower voltage needed to charge battery packs. To supply AC power to power consuming devices in the field, PDU 104 receives DC power from ESM 102 via DC bus 228. In this particular embodiment, 48 VDC IN/OUT block supplies this DC power to inverter 223 which converts this DC power to AC power that it supplies via 120 VAC OUT block 224 to AC bus 220. AC bus 220 connects to an AC connector on the front panel of PDU 104 where a user may connect a particular desired power consuming device to receive AC power in the field.

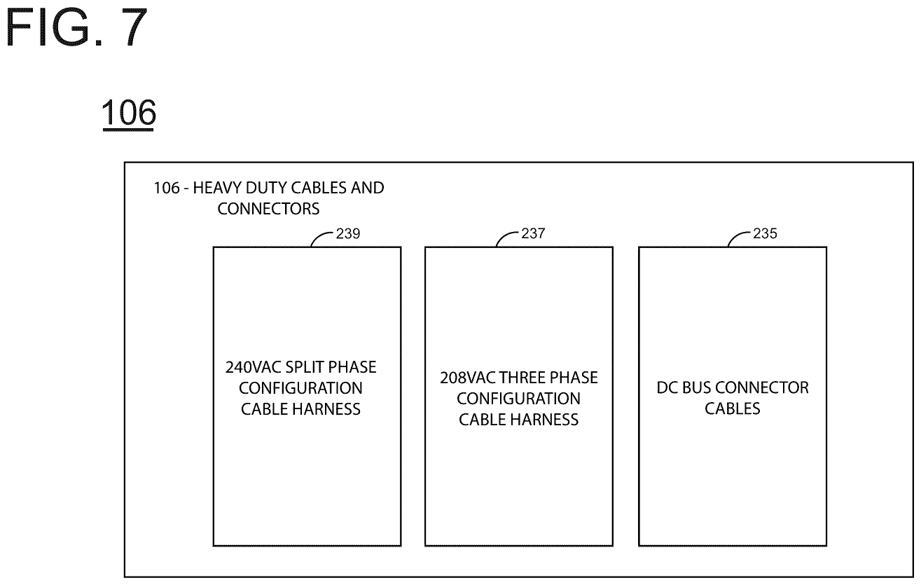

FIG. 7 shows representative heavy-duty cables and connectors 106 as including DC bus connector cables 235, 208 VAC three phase configuration cable harness 237 and 240 VAC split phase configuration cable harness 239. DC bus connector cables 235 couple PDU 104 to ESMs 102. If the user desires PDU 104 to output 208 VAC three phase on its front panel AC connector, then the user employs 208 VAC three phase configuration harness 237. Alternatively, if the user wants PDU 104 to output 240 VAC split phase on its front panel AC connector, then the user employs 240 VAC split phase configuration cable harness 239.

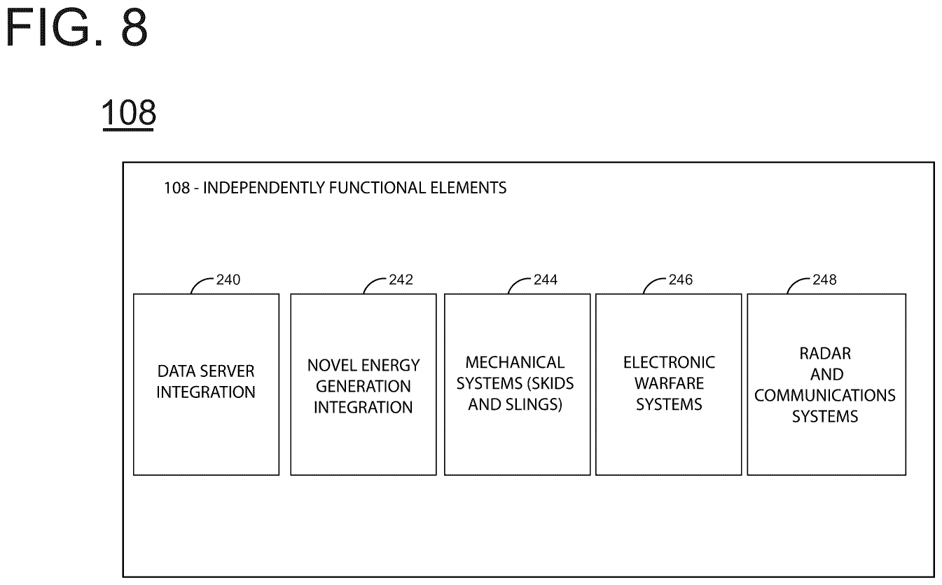

FIG. 8 shows representative independently functional elements 108. Independently functional elements 108 can include data server integration 240, novel energy generation integration 242, mechanical systems (skids and slings), electronic warfare systems 246, and radar and communication systems 248. For example, a data server computer 240 may be integrated within the METEOR system to store data collected from ESMs 102. As new energy generation technology is developed, that technology may be readily integrated within the METEOR system as per block 242. Another example of independently functional elements 108 is mechanical systems such as skids and slings. Other independently functional elements 108 that may be incorporated in the METEOR system include electronic warfare systems 246 as well as radar and communication systems 248.

FIG. 9 is a flowchart depicting process flow in the load identification module 900 of the METEOR system. A user connects a device, i.e. a power consuming device, to a PDU 104 or an ESM 104, as per block 902. The load identification module 900 identifies the particular electrical device by receiving metrics from the device and comparing the metrics with information in a database that may be situated at a predetermined location, such as indicated in block 912. In more detail, as per block 904, load identification module 900 measures a single or combination of voltages, currents, resistance, impedance and other metrics of the device over time via the PDU or ESM to which the device is connected. Load identification module 900 collects this metrics data and stores the data locally on the device, as per block 906. A local compute operation parses the data for transmission, as per block 908. Load identification module 900 transfers the data, as per block 910, by local area network, satellite network, or cellular network to a local or remote server that receives the data and the stores the data in a database, as per block 912. Load-specific data is retrieved from the database, as per block 914. The data is analyzed to find matching loads signatures in the database, as per box 916. Expected peak and continuous power draw are determined including those load signatures, as per block 918. If the load is determined to be correctly matched to the PDU or ESM as per load matching test block 920, then control data is sent back to the PDU or ESM to optimize the system for attached power consuming devices. The results of these operations are displayed in the user interface as per block 922.

In addition to sending the load-specific data to load matching test block 920 as per block 918, as seen in block 918 the system also sends the load-specific data to load matching test block 924 of the FIG. 10 flowchart. FIG. 10 shows process flow in power comparing component module 1000. The system conducts a test at load matching test block 924. If the load is determined to be incorrectly matched to the PDU or ESM at block 924, then power component pairing module 1000 accesses the database to retrieve historical data, for example in one embodiment via a retrieval augmented generation (RAG)-enhanced large language model (LLM), as per block 926. More specifically, power component pairing module 1000 accesses the historical data to determine the necessary PDU or ESM equipment to service the load. Power component pairing module 1000 can run a simulation model, as per block 928, to confirm the appropriateness of the PDU or ESM equipment determined in block 926. The user interface displays results of the PDU or ESM equipment change to the user, as per block 930.

FIG. 11 and FIG. 12 together show the runtime calculator of the system. More particularly, FIG. 11 is a flowchart depicting process flow associated with the runtime calculator (PDU side) 1100 in process flow steps 1102 to 1122, while FIG. 12 depicts process flow associated with the runtime calculator (ESM side) 1200 in process flow steps 1220 to 1224. The runtime calculator determines a prediction of the current run time for a particular ESM or ESMs collectively.

With respect to the FIG. 11 runtime calculator (PDU side) 1100, a user connects one or more power consuming devices to a PDU or ESM, or to a power node consisting of one or more PDUs or ESMs or both, as per block 1102. One of, or a combination of, voltages, currents, resistances, impedances and other metrics are measured over time via the PDU or ESM, as per block 1104. As per block 1106, this data is collected and stored locally on PDU or ESM devices at the source power node, as per block 1106. In other words, this data is stored at the source, namely the PDU or ESM where it is connected to the power consuming device of block 1102. This data is then parsed for transmission, as per block 1108, and transmitted via local area network, satellite network, public or private cellular network, as per block 1110. The transmitted data is received by a local or remote server and stored in the database, as per block 1112. Load-specific data is retrieved from the database, as per block 1114. The data is analyzed to find matching load signatures in the database, as per box 1116. Expected peak and continuous power draw are determined for those load signatures, as per block 1118. Average power draw over a predefined time period for the power node is determined, as per block 1120. Data including peak and continuous power draw and average power draw are linked to the associated power node and stored, as per block 1122.

Referring now to the FIG. 12 runtime calculator (ESM side) 1200, the runtime calculator uses telemetry from each ESM to determine the power distribution unit (PDU), node, or group it is connected to, as per block 1202. The current state of charge (SoC) and state of health (SoH) of each of these ESMs and any internal battery core packs therein are determined to a high degree of accuracy, as per block 1204. This state of charge (SoC) and state of health (SoH) data is collected continuously at predetermined intervals and stored locally on the device at the source. as per block 1206. This data is then parsed for transmission, as per block 1208, and transmitted via local area network, satellite network, public or private cellular network, as per block 1210. The transmitted data is received via a local or remote server and stored in the database therein, as per block 1212. Next, as per block 1214, energy-specific data is retrieved from the database referenced in block 1212. The data is analyzed to determine overall SoC and SoH of ESMs in the power node, as per block 1216. Machine learning can be used to perform this analysis. The expected average power draw is retrieved for this power node, as per block 1218. The expected runtime of this power node is calculated from power data and energy data, as per block 1220. Next, as per block 1222, corrective actions if necessary are recommended to the user, such as for example adding or removing modules as discussed above in paragraph 0037 and in paragraph 0050 with reference to FIG. 3. The modular design of the ESMs and PDUs allows for the system to be scaled up or down by adding, removing, changing, or replacing modules based on current operational requirements. Results of taking the recommended corrective action to handle the power consuming devices connected as described above in block 1102 are displayed to the user by the user interface, as per block 1224.

FIGS. 13A-13D depict a representative user interface for the METEOR system, namely an operational energy dashboard. FIG. 13A shows a login screen 1305 for this dashboard that provides the user with controlled access to the system. FIG. 13B is a map view 1310 showing “Node 1” via the dashboard. A node is a zone or locale where a PDU or other module is located to provide power to users. It can display power remaining (e.g. 55%) and/or power currently being consumed (e.g. 450 W) at that location. It is also possible to search for a particular mission by name via “Search for Mission Name” input field 1315. FIG. 13C shows an operational energy dashboard view 1320 that displays power parameters at Nodes 1-5 for a particular mission named Bravo. FIG. 13D shows inside the power node view 1325 (for example, Node 1) including displaying voltage, power and temperature parameters for the TPMs (PDUs) and TEMs (EMSs) in Node 1. This view can also show solar array information such as voltage, power, efficiency and estimated sunlight remaining.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A modular energy storage and delivery system, comprising:
a plurality of standardized energy storage modules (ESMs) (102) for storing energy;
at least one power distribution unit (PDU) (104) configured to distribute power from the energy storage modules to connected devices;
a plurality of connectors (106) for interconnecting the energy storage modules and the PDU;
a user interface (208) for system configuration and monitoring; and
a software application comprising:
a load identification module for categorizing electrical loads;
a power component pairing module for matching identified loads with suitable power components; and
a runtime calculator for estimating operational runtime based on system configuration and load data.

2. The system of claim 1, wherein the energy storage modules are designed for quick assembly without requiring technical expertise.

3. The system of claim 1, wherein the energy storage modules comprise rugged enclosures customizable with different materials to withstand specific environmental conditions.

4. The system of claim 3, wherein the rugged enclosures provide at least one of weather resistance and ballistic impact protection.

5. The system of claim 1, wherein the system is scalable by adding, removing, or reconfiguring modules, units, groups, or grids.

6. The system of claim 1, wherein the PDU integrates charging capabilities for recharging the energy storage modules from various power sources.

7. The system of claim 1, wherein the software application further comprises artificial intelligence (AI) and machine learning (ML) components for optimizing power management and system configurations.

8. The system of claim 7, wherein the AI and ML components are configured to:
collect data from user interactions and system performance logs;
build predictive models for optimal configurations; and
continuously adapt to changing operational conditions and user preferences.

9. The system of claim 1, further comprising independently functional elements integrated within the modules, wherein the independently functional elements include at least one of communications, mechanical, or electrical systems.

10. The system of claim 1, further comprising remote monitoring and control capabilities for centralized management of the power infrastructure across multiple tactical units or locations.

11. A method for deploying and operating a modular energy storage and delivery system, comprising:
deploying a plurality of standardized energy storage modules (102);
configuring at least one power distribution unit (PDU) (104) to distribute power from the energy storage modules to connected devices;
interconnecting the energy storage modules and the PDU using a plurality of connectors (106);
identifying and categorizing electrical loads using a load identification module;
matching identified loads with suitable power components using a power component pairing module;
estimating operational runtime based on system configuration and load data using a runtime calculator; and
monitoring and controlling the system via a user interface (208).

12. The method of claim 11, further comprising assembling the energy storage modules without requiring technical expertise.

13. The method of claim 11, further comprising customizing rugged enclosures of the energy storage modules with different materials to withstand specific environmental conditions.

14. The method of claim 11, further comprising scaling the system by adding, removing, or reconfiguring modules, units, groups, or grids based on operational requirements.

15. The method of claim 11, further comprising recharging the energy storage modules using charging capabilities integrated into the PDU.

16. The method of claim 11, further comprising optimizing power management and system configurations using artificial intelligence (AI) and machine learning (ML) components.

17. The method of claim 16, wherein optimizing power management and system configurations comprises:
collecting data from user interactions and system performance logs;
building predictive models for optimal configurations; and
continuously adapting to changing operational conditions and user preferences.

18. The method of claim 11, further comprising integrating independently functional elements within the modules, wherein the independently functional elements include at least one of communications, mechanical, or electrical systems.

19. The method of claim 11, further comprising remotely monitoring and controlling the power infrastructure across multiple tactical units or locations.

20. The method of claim 11, further comprising:
detecting changes in power requirements during tactical operations;
dynamically reassessing the optimal configuration of energy storage modules and PDUs; and
reconfiguring the system to accommodate updated load profiles.
